(19) United States
(12) Patent Application Publication
(10) Pub. No.: US 2009/0058653 A1
(43) Pub. Date: Mar. 5, 2009

(54) HOSPITAL INVENTORY MANAGEMENT INCLUDING RADIO TAG(S) AND ADDITIONAL TRANCEIVER(S)

(76) Inventors: Randolph K. Geissler, Hudson, WI (US); Steven Lewis, Bloomington, MN (US); Nelson Scott Alan, Eagan, MN (US)

Correspondence Address: MERCHANT & GOULD PC, P.O. BOX 2903, MINNEAPOLIS, MN, 55402-0903, US

(21) Appl. No.: 12/044,177

(22) Filed: Mar. 7, 2008

Related U.S. Application Data
(60) Provisional application No. 60/967,739, filed on Sep. 5, 2007.

(51) Int. Cl. G08B 13/14

(52) U.S. Cl. 340/572.1

(57) ABSTRACT

The present invention relates to a hospital inventory management system including a radio tag, a beacon configured to monitor the proximity of the radio tag, and a reader configured to read information from the tag and the beacon.

### CROSS REFERENCE TO RELATED APPLICATIONS

This application claims priority to U.S. Provisional Application Ser. No. 60/967,739, filed Sep. 5, 2007, entitled “HOSPITAL INVENTORY MANAGEMENT INCLUDING RADIO TAG(S) AND ADDITIONAL TRANSCEIVER(S),” the disclosure of which is hereby incorporated by reference herein.

### FIELD OF THE INVENTION

The present invention relates to hospital inventory management including at least one radio tag, at least one reader/beacon configured to monitor the proximity of the radio tag, and a data manager configured to read information from the radio tags and/or the beacons.

### BACKGROUND

Hospitals may buy more equipment than needed due to problems in locating and tracking the equipment. These expenditures raise the cost of supplies. In addition, care givers can suffer delays in response times if the care givers cannot locate necessary equipment.

### SUMMARY

The present invention relates to hospital inventory management including a radio tag, a reader/beacon configured to monitor the proximity of the radio tag, and a data manager configured to read information from the tag and the beacon. The radio tag can be coupled to an item of hospital inventory for monitoring, locating, and tracking purposes.

### BRIEF DESCRIPTION OF THE FIGURES

FIG. 1 is a schematic block diagram of a hospital inventory management system having features that are examples of inventive aspects in accordance with the principles of the present disclosure;

FIG. 2 is a schematic block diagram of an inventory table for managing inventory items by assigned identification numbers in accordance with the principles of the present disclosure;

FIG. 3 is a schematic block diagram of an inventory database including multiple relational databases in accordance with the principles of the present disclosure;

FIG. 4 is an example data manager configured to implement an inventory database in accordance with the principles of the present disclosure;

FIG. 5 is a flowchart illustrating an operational flow for a scanning process by which a beacon determines what tagged inventory items are in proximity to the beacon in accordance with the principles of the present disclosure;

FIG. 6 is a flowchart illustrating an operational flow for a response process by which a radio tag responds to the beacons by sending identification information to the beacon in accordance with the principles of the present disclosure;

FIG. 7 is a flowchart illustrating an operational flow for a broadcasting process by which a radio tag transmits an identification signal in accordance with the principles of the present disclosure;

FIG. 8 is a flowchart illustrating an operational flow for a reporting process implemented by a reader when a radio tag enters the vicinity of the reader in accordance with the principles of the present disclosure;

FIG. 9 is a flowchart illustrating an operational flow for an example recordation process by which a data manager associates an inventory item with a location in accordance with the principles of the present disclosure;

FIG. 10 is a flowchart illustrating an operational flow for a query process by which a user can look up a location of a tagged item in accordance with the principles of the present disclosure;

FIG. 11 illustrates an example application of a hospital inventory management system having features that are examples of inventive aspects of the principles of the present disclosure;

FIG. 12 is a schematic block diagram of an example inventory tag that may be utilized in any animal management system disclosed herein; and

FIG. 13 is a schematic block diagram of an example beacon that may be utilized with any inventory management system disclosed herein.

### DETAILED DESCRIPTION

### Definitions

As used herein, the term “hospital inventory” refers to any hospital equipment or parts thereof capable of being moved about a hospital. Examples of hospital inventory include hospital furniture, medical supplies, surgical instruments, and other equipment found in hospitals. For example, hospital inventory can include mobility aids (e.g., canes, quad-canes, crutches, wheelchairs, walkers, rollators, and mobility scooters), diagnostic supplies (e.g., scales, physician/lab microscopes, blood pressure monitors, heart rate monitors, and ultrasound machines), respiratory and sinus infection treatment supplies (e.g., purifiers and humidifiers), durable supplies (e.g., gurneys/trolleys, stretchers, adjustable hospital beds, ICU beds, bed canopy systems, bassinets, incubators, rollaway beds, massage tables, and pumps), medical utility carts (e.g., anesthesia carts, cast carts, crash/emergency carts, food serving carts, isolation carts, medication carts, physician carts, and treatment carts), emergency room supplies (e.g., portable defibrillators), and surgical instruments (e.g., colposcopes, I.V. stands, and examination lamps). This list of hospital inventory is intended to be illustrative only, and should not limit the scope of the following disclosure related to the present invention.

As used herein, the term “management” refers to identifying, locating, tracking, and/or monitoring of hospital inventory or other objects of interest, for whatever purpose or reason.

### Hospital Inventory Management

The present disclosure includes systems and methods for managing hospital inventory to monitor, locate, and/or track inanimate objects (e.g., I.V. stands, wheelchairs, gurneys, etc.) within a hospital environment. The hospital inventory management system includes a radio tag, which can have features in addition to those described herein. The hospital inventory management system can include at least one radio tag (e.g., an RFID device), at least one reader or beacon, and a data manager.

Managing hospital inventory can include automatically monitoring the location within the hospital of each tagged item. Consequently, the items can be found when needed without searching. In particular, the tagged items can be found without the need for remembering where a given tagged item was left or consistently recording the location of each tagged item. Tagged item locations can be forgotten and manually logging the location of items can be foregone in an emergency or during a busy period. Managing hospital inventory in accordance with the principles of this disclosure allows items to be located quickly regardless of the diligence of the hospital staff or the activity level on the floor.

In an embodiment, the tag includes an identifying indicia. In this embodiment, the tag can be configured to respond to a query only when addressed by the identifying indicia. In an embodiment, the system includes a plurality of tags. In such an embodiment, each tag can include a distinct identifying indicia and can be configured to respond to a query only when addressed by its distinct identifying indicia.

In some embodiments, hospital inventory management system includes an RFID device (e.g., a radio tag) for each item to be tracked, an reader/beacon located in one or more rooms and/or hallways of the hospital, and a central data manager or processor with to store the collected data from the RFID device. In an embodiment, readers/beacons are spaced at regular locations within the hospital.

In certain embodiments, the RFID devices coupled to the items are active inventory tags. The power source for the active tag can include a battery (e.g., an internal battery). Generally, the active inventory tags communicate with readers arranged within the hospital. As the term is used herein, the term “reader” refers to a device configured to receive and process RFID signals. In other embodiments, however, the RFID devices are passive inventory tags. Generally, the passive inventory tags communicate with beacons arranged within the hospital. As the term is used herein, the term “beacon” refers to a device configured to transmit, receive, and process RFID signals. In other embodiments, however, active inventory tags can operate with beacons and passive inventory tags can operate with readers.

In general, the RFID devices on the tagged items are each configured to transmit or broadcast a unique identification signal, which is received by the reader/beacon in whichever room, hallway, or location the tagged item is currently located. The room readers/beacons report the location of the tagged item to the data manager.

According to aspects of the disclosure, a beacon periodically scans for tags and reports to the data manager when a tag is found in the vicinity of the beacon. In an embodiment, the beacon reports an indication of which items are currently located within the room based on the scan. For example, the beacon may periodically broadcast requests for identification signals to any tags within range. In an embodiment, the room readers continuously broadcast requests for identification signals. The tags react to the broadcasted requests by broadcasting their respective identification signal in response. In an embodiment, the beacon receives these responses and reports to the data manager the identification numbers received. In another embodiment, the beacon receives the responses, determines if any previously unreported tags have entered the beacon's range, and reports the identification numbers of the previously unreported tags to the data manager.

According to other aspects of the disclosure, an RFID device of the tagged item periodically broadcasts an identification signal, which is received and processed by any reader within range. A reader can report an identification signal detected to the data manager when the tagged item and radio tag come within range of the reader (e.g., enter the room in which the reader is arranged).

According to other aspects of the disclosure, the data manager receives reports from the readers and/or beacons and compiles the reports into a location log. In certain embodiments, the location log is a database. In an embodiment, the location log is a database arranged (i.e., keyed) based on the identification numbers of the tagged items. In another embodiment, the location log includes relational databases. For example, each tagged item (i.e., identification number) can be associated with its own database.

Generally, the data manager tracks the current location of each tagged item via the identification number. In an embodiment, the data manager also tracks entry and/or exit events of the tagged items. Entry events indicate when a tagged item has entered a particular location (e.g., a room). Exit events indicate when a tagged item has left a particular location. In an embodiment, the data manager determines a time at which a reader or beacon first reports receiving a particular identification signal. In another embodiment, the reader or beacon determines the time at which the identification signal was sensed and reports the time to the data manager.

In certain embodiments, the data manager maintains a history for each tagged item. For example, the data manager can store the locations in which a tagged item has been reported. In an embodiment, the data manager can store the time at which the tagged item was first reported to be in the location. Additionally, the data manager can store the time at which the tagged item was first reported to have left the location.

In an embodiment, the inventory tag includes identifying indicia and the reader/beacon is configured to query the tag with its identifying indicia and is configured to transmit information to the tag, to receive information from the tag, or combination thereof. For example, the beacon can be configured to obtain tag-specific information from the tag, to store the tag-specific information, and to transmit the tag-specific information to the reader. By way of further example, the information can be tag-specific information, general information, or a combination thereof.

In certain embodiments, the readers/beacons store information relating to themselves and to the radio tags with which the readers/beacons have come into contact. For example, the readers/beacons can store a location identification number or other location information, which the beacon or reader can broadcast to the inventory tag. The readers/beacons also can store information identifying tagged items with which the readers/beacons have come into contact. For example, the readers/beacons can store information indicating the tagged items currently within range of the readers/beacons. In another embodiment, the readers/beacons can store information indicating tagged items that been in proximity to the readers/beacons within a predetermined period of time. In other embodiments, the readers/beacons can store other types of information received from the inventory tags. In still other embodiments, the room readers merely act as relays between the inventory tags and the data manager.

In an embodiment, the beacon is configured to measure the time the inventory tag is in proximity to the beacon and to transmit the measured time to the inventory tag, the data manager, or combination thereof. In an embodiment, the beacon is configured to store in memory and transmit to the reader the measured time specific to the inventory tag.

The inventory tag can receive information (e.g., location information, reader/beacon information, etc.) from the readers/beacons. In an embodiment, the beacon periodically broadcasts a location identification number and/or other location information, which can be received and stored by radio tags within the vicinity of the beacon. In another embodiment, the reader transmits and/or broadcasts a location identification number and/or other location information when the reader receives an identification signal from the inventory tag.

The inventory tag can include memory in which to store the received location identification number and/or location information. In an embodiment, the inventory tag stores only the current location of the tagged item. In another embodiment, the inventory tag stores a history of locations at which the tagged item has been. In still other embodiments, the inventory tag can store additional information pertaining to the item (e.g., a maintenance status, a description of the item, a classification of the item, etc.).

In certain embodiments, the inventory tag can retrieve information (e.g., location information, information pertaining to the tagged item, etc.) stored within memory and transmit the information upon request. For example, a reader or beacon can send a query signal to the inventory tag and the inventory tag can respond with the retrieved information. In some embodiments, the reader/beacon receives only identifying information (e.g., an identification number) from the RFID device. In other embodiments, the reader/beacon can obtain other information pertaining to the tagged item (e.g., a designated location for the item, an event history of the item, etc.) from the RFID device.

The inventory tag can be packaged within an outer housing. For example, the inventory tag can be packaged as a bumper (e.g., a housing configured to withstand more than just general wear and tear). In an embodiment, the outer housing is configured to adhesively secure to a tagged item. In another embodiment, the outer housing is configured to couple to a tagged item through a hook and thread fastener. In other embodiments, however, the outer housing can be configured to couple to the tagged item through any fastening process (e.g., welding, tying, gluing, magnets, or with any desired fastener).

### System

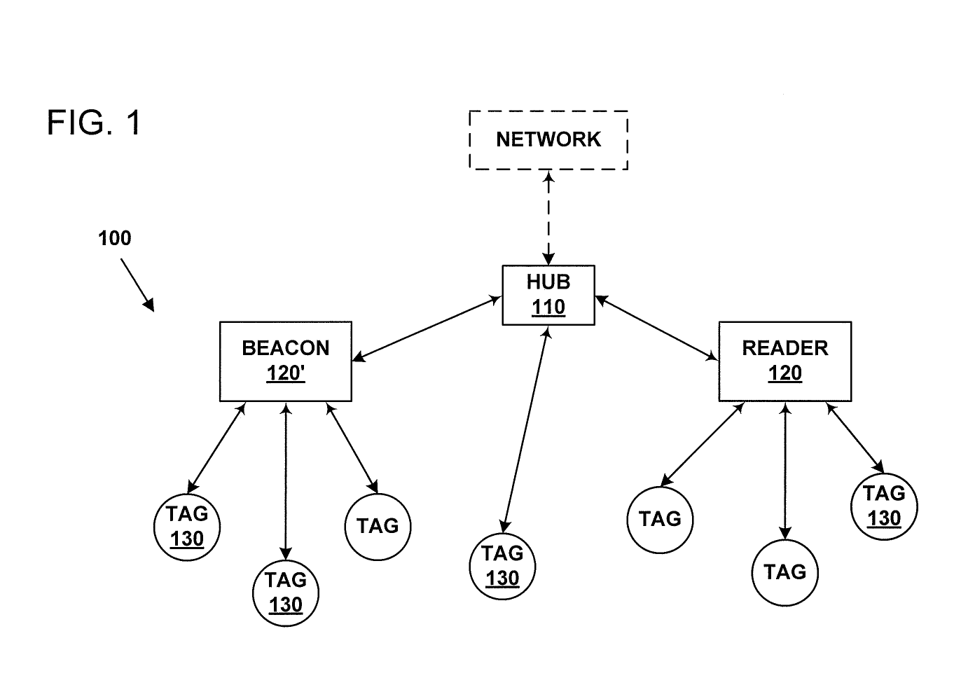

FIG. 1 is a block diagram of a hospital inventory management system 100 having features that are examples of inventive aspects in accordance with the principles of the present disclosure. The management system 100 includes a data manager 110 and a plurality of radio tags 130. The management system also includes at least one reader 120, at least one beacon 120′, or a combination thereof. Optionally, the data manager 110 can be communicatively coupled to a network 140 (e.g., a database, an intranet, the internet, etc.).

Generally, the radio tags 130 communicate with the readers 120 and beacons 120′. The readers 120 and beacons 120′ communicate with the data manager 110. In different embodiments, the radio tags 130 can communicate directly with the data manager 110. Optionally, the management system 100 can include additional layers (e.g., intermediate data managers) (not shown). For example, in an embodiment, each floor of the hospital may have an intermediate data manager which communicates with the readers 120 and beacons 120′ on the floor. The intermediate data managers communicate with the central data manager 110.

### Radio Tag

The present invention relates to a radio tag. In general, the radio tag can include a first radio transceiver, a power source, and a first data processing system. The first radio transceiver can be configured to transmit identification indicia, information pertaining to the tagged item, or a combination thereof to a beacon and/or to the data manager. In an embodiment, each beacon communicates with the data manager.

The radio tag can include a first radio transceiver, a power source, and a first data processing system. The first radio transceiver can be configured to transmit identification indicia, tag-specific information, or combination thereof to a reader. The tag can be configured to communicate with a data manager on a first frequency and to communicate with a proximal reader/beacon on a second frequency. The data manager can be distant from the tag.

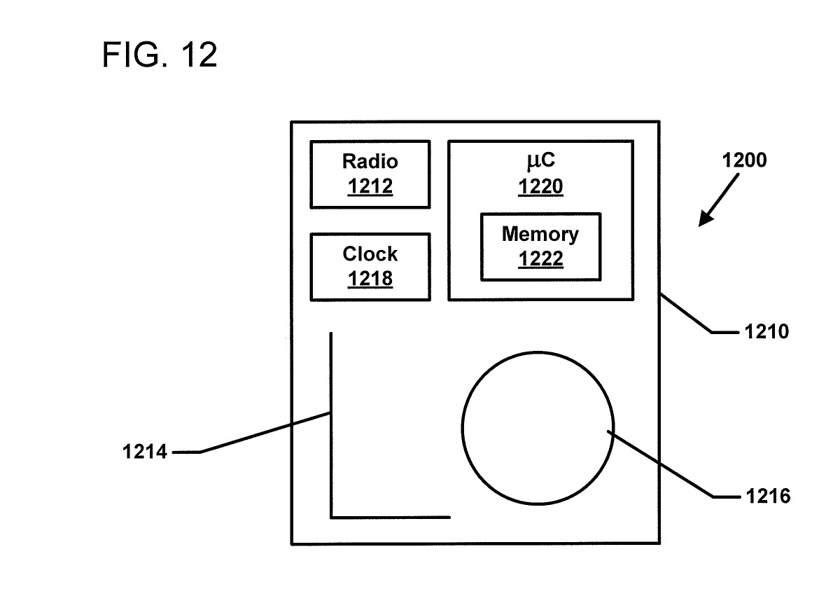

FIG. 12 is a schematic block diagram of an example inventory tag 1200 that may be utilized in any animal management system disclosed herein. The inventory tag 1200 includes a housing 1210 containing a radio transceiver 1212, an antenna 1214, and a battery 1216. In general, the transceiver obtains power from the battery 1216 to broadcast a radio signal through the antenna 1214. An example of a suitable radio transceiver includes the nRF24L01 Single Chip 2.4 GHz Transceiver from Nordic Semiconductor of Trondheim, Norway. In an embodiment, the antenna 1214 includes an inverted -L antenna. In other embodiments, however, any suitable antenna 1214 may be used to broadcast the radio signals.

The housing 1210 also may contain a clock 1218 and a microcontroller 1220 including memory 1222. The memory 1222 of the microcontroller 1220 may store operating instructions, operating parameters, and data. The memory 1222 may include volatile (e.g., RAM) and non-volatile (e.g., flash) memory. For example, in an embodiment, the memory 1222 may store a unique identifier for each tag or tagged item. In another embodiment, the memory 1222 may store a history of the tagged item. In another embodiment, the memory 1222 stores an operating parameter indicating a broadcast interval for the inventory tag 1200 based on a number of clock cycles 1218. An example of a suitable clock 1218 includes a 16 MHz crystal.

In an embodiment, the microcontroller 1220 implements a data processing system that receives any data sent from beacons and/or readers, analyzes the data, stores the data in the memory 1222, and transmits reply data as appropriate. In an embodiment, the data processing system is hardwired within the microcontroller 1220. In another embodiment, the data processing system is implemented via software installed on the microcontroller 1220. In an embodiment, the microcontroller 1220 also may include matching circuitry to tune the antenna 1214.

In an embodiment, the radio tag is configured to transmit over a distance of 25 meters or more. In another embodiment, the tag is configured to transmit over a distance of about 100 feet. In an embodiment, the inventory tag is configured to transmit over a distance sufficient for the tag to be read on a tagged item located within a hospital room by a reader or beacon positioned on an opposite side of the hospital room. In an embodiment, the tag can have a power source. The power source for the tag can be a battery. For example, an active tag can receive power from a battery with a battery life of about five years.

For example, in an embodiment, the signals transmitted by the radio tag may not be capable of penetrating a solid wall. In another embodiment, the radio tag may not be capable of transmitting signals over a distance greater than the size of the room. For example, the transmission range of the radio tag may be limited to about three meters, six meters, nine meters, twelve meters, fifteen meters, or more.

The tag can include any of a variety of transceivers. In an embodiment, the first transceiver and the first data processing system are on a single printed circuit board, the single printed circuit board defining an area no larger than a conventional radio tag. For example, the first transceiver can include or be a radio that meets IEEE Standard 802.15.4 (a ZigBee type radio). IEEE Standard 802.15.4 and other IEEE standards relevant to ZigBee type radios are incorporated herein by reference. Additional standards relating to ZigGee type radios are known.

In an embodiment, the tag includes an identifying indicia. In this embodiment, the tag can be configured to respond to a query only when addressed by the identifying indicia. The tag can include a distinct identifying indicia and can be configured to respond to a query only when addressed by its distinct identifying indicia. The tag can be configured to transmit and store information, for example, information gathered or determined about the tagged item. For example, the tag can be configured to store in memory and transmit to the reader, the beacon, or the data manager the amount of time that the tag is in proximity to the reader or the beacon.

In an embodiment, the radio tag can be packaged within an outer housing. For example, the radio tag can be packaged as a bumper (e.g., a housing configured to withstand more than just general wear and tear). In an embodiment, the outer housing is configured to adhesively secure to a tagged item. In another embodiment, the outer housing is configured to couple to a tagged item through a hook and thread fastener. In other embodiments, however, the outer housing can be configured to couple to the tagged item through any fastening process (e.g., welding, tying, gluing, magnets, or with any desired fastener).

### Reader/Beacon

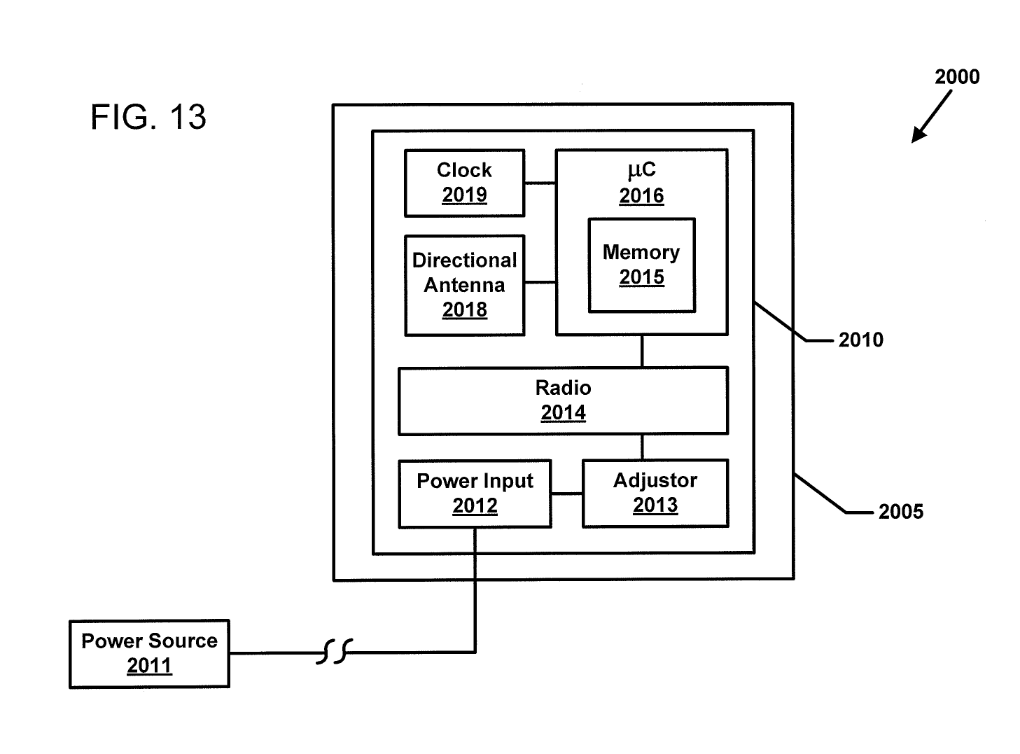

FIG. 13 is a schematic block diagram of an example beacon 2000 that may be utilized with any inventory management system disclosed herein. The beacon 2000 includes a radio transceiver 2014, a microcontroller 2016, and an antenna 2018. In an embodiment, the beacon 2000 also includes a clock 2019 (e.g., a crystal) with which the microcontroller 2016 may time periodic intervals at which radio signals are to be broadcast from the antenna 2018. In an embodiment, the antenna 2018 includes a directional antenna. In another embodiment, the antenna 2018 may include any suitable antenna. In an embodiment, the microcontroller 2016 contains memory 2015 storing information to be broadcast on the radio signals.

In an embodiment, the beacon 2000 may receive information from a data manager (e.g., the data manager 110 of FIG. 1) to be distributed to one or more inventory tags, such as inventory tags 130 of FIG. 1. For example, the beacon 2000 may distribute instructions to the active tags to check in more or less often. Advantageously, broadcasting information to inventory tags via the beacon 2000 may allow quick distribution of the information. In an embodiment, broadcasting the information via one or more beacons 2000 provides the information to the inventory tags without waiting for individual tags to check in.

In some embodiments, the beacon 2000 receives power from an external power source 2011. In an embodiment, the beacon 2000 receives power from the external power source 2011 at a power input 2012, which supplies the power to the remaining beacon components. In an embodiment, the external power source 2011 is a battery. In another embodiment, the external power source is an electrical outlet or other power source. In other embodiments, the beacon 2000 includes an internal power source (not shown), such as a battery, a solar cell, or other such component.

In an embodiment, the beacon 2000 includes an adjustor component 2013 to amplify or decrease power before distributing the power within the beacon 2000. For example, the adjustor component 2013 may include a resistor to load down the beacon 2000, thereby decreasing the range of the beacon 2000. Advantageously, decreasing the range of the beacon 2000 may aid in controlling the size and/or shape of the range of the beacon 2000. In another embodiment, the adjustor component 2013 may facilitate power gain, thereby amplifying the range of the beacon 2000. Advantageously, amplifying the range of the beacon 2000 may facilitate communication with a reader and/or a data manager.

In an embodiment, the components of the beacon 2000 are arranged on a circuit board 2010 or other support structure. In some embodiments, the beacon components are sealed within an outer housing 2005. In an embodiment, the outer housing 2005 protects the beacon components from environmental conditions, such as precipitation, dust, dirt, wind, sun exposure, and animals (e.g., animals being tracked, rodents, insects, and/or other pests). In an embodiment, the outer housing 2005 may be molded (e.g., injection-molded) over the beacon components. In other embodiments, the housing 2005 only contains the beacon components, but does not protect the components from environmental conditions.

The present invention relates to a beacon. The beacon can include any of a variety of transceivers. For example, the second transceiver can include a radio that meets IEEE Standard 802.15.4 (a ZigBee type radio). The beacon can be configured to receive transmission from a radio that meets IEEE Standard 802.15.4 (a ZigBee type radio).

The beacon can include a second radio transceiver and a second data processing system. The second radio transceiver can be configured to communicate with a radio tag according to the present invention over a second frequency when the radio tag is in proximity to the beacon. The second radio transceiver can be configured to communicate with a reader over a first radio frequency with power sufficient to transmit over a distance sufficient to communicate with a radio tag of a tagged item.

The beacon can be configured to communicate with the reader over the first frequency at a first power level and to communicate with the tag at a second power level. The first power level can be greater than the second power level. In an embodiment, the beacon is also configured to communicate with the tag over the first frequency at the first power level.

The system includes a beacon, which can have features in addition to those described herein. The beacon can be located at any site within the hospital environment at which it is desired to track the proximity of tagged inventory items. The beacon can be at a site within the facility (e.g., patient room, storage room, hallway, operating room, lounge, etc.) at which it can communicate with the data manager. In an embodiment, the beacon is mounted within each room of the hospital or at intervals along hallways. A beacon also can be mounted within elevators and/or stairwells. The system can include a plurality of beacons within a single room or along a hallway.

The beacon can be configured to maintain adequate strength of its field in the region, volume, or area in which it is desired that the system track the presence of the radio tag(s) with the beacon. In an embodiment, the beacon is configured communicate with one or more radio tags over a distance of 25 meters. In another embodiment, the beacon is configured to communicate with one or more radio tags over a distance of 3 meters or less. In an embodiment, the beacon is configured communicate with the radio tag over a distance from a tagged item to a location within the hospital environment at which the beacon is located.

For example, the beacon can be shielded to shape its field. In an embodiment, the beacon is shielded to configure its field to cover a volume occupied by a hospital room. In an embodiment, the beacon is shielded to limits its field to avoid covering a particular location, such as a room housing delicate equipment or RFID readers for different RFID systems. Shielding can be employed with the tag coupled to each item of hospital inventory.

In an embodiment, the beacon can be mounted to one of the walls of the room or hallway. In another embodiment, the beacon can be mounted on the ceiling or in the floor. In another embodiment, the beacon can stand alone or be placed on an object within the room or hallway. In an embodiment, the beacon is configured to be unable to communicate with the radio tags when the radio tags are outside of the room. For example, in an embodiment, the signals transmitted by the beacon may not be capable of penetrating a solid wall. In another embodiment, the beacon may not be capable of transmitting signals over a distance greater than the size of the room. For example, the transmission range of the beacon may be limited to about three meters, six meters, nine meters, twelve meters, fifteen meters, or more.

In an embodiment, the system includes a plurality of tags. In such an embodiment, the beacon can be configured to query each tag with its distinct identifying indicia. The beacon can then transmit information to the tag, receive information from the tag, or combination thereof. The information can be tag-specific information, general information, or a combination thereof. In an embodiment, the beacon is configured to measure time each tag is in proximity to the beacon. The beacon can then transmit each measured time to the specific tag, the data manager, or combination thereof. In an embodiment, the beacon is configured to store in memory and transmit to the data manager the measured time specific to each tag. In an embodiment, the system includes a plurality of tags and the beacon is configured to obtain tag-specific information from each tag, to store the tag-specific information for each tag, and to transmit the tag-specific information for each tag to the data manager.

In an embodiment with a plurality of tags, the beacon can be configured to communicate with the data manager over the first frequency at a first power level and to communicate with each tag at a second power level. The first power level can be greater than the second power level. The beacon can be configured to communicate with the tag over the first frequency at the first power level (as well as the second power level). Alternatively, the reader/beacon can communicate with the data manager via a cable, telephone cord, wireless connection, or any other communication transmission mechanism.

### Data Manager

The data manager can include a third radio transceiver and a third data processing system. The data manager is configured to write item-specific information to a radio tag of an inventory item. The item-specific information can include, for example, information about a designated location for the item, a description of the item, a maintenance status of the item, or a combination thereof. The data manager can be configured to receive transmission from a radio that meets IEEE Standard 802.15.4 (a ZigBee type radio).

In an embodiment, the data manager can be configured to interrogate and write to the radio tag, the reader/beacon, or combination thereof at a first frequency and a first power level.

The system includes a data manager, which can include features in addition to those described herein. The data manager can be located at any site within a hospital suitable for receiving transmissions from the tag, the beacon, and/or a hospital network (e.g., an inventory network, an intranet, the internet, etc.). In an embodiment, the data manager is near or within transmission range of a tagged inventory item. For example, the data manager can be proximal a shielded location, a locked room, or even offsite (i.e., not located within the hospital environment).

In general, the data manager is configured to communicate with the readers/beacons. The data manager also can communicate directly with the radio tags. For example, the data manager can communicate with the beacons or tags via an RFID signal. Alternatively, the data manager can communicate with the beacons via a wireless frequency connection, a cable connection, or by other communications technology.

The present invention relates to a data manager. In an embodiment, the data manager is configured to transmit over a distance of 25 meters or more. In an embodiment, the data manager is configured to transmit over a distance sufficient for the data manager to be located external to the hospital environment and to still be able to transmit information to a reader/beacon and/or to a radio tag. Alternatively, the data manager can be located within the hospital environment.

In an embodiment, the tag includes an identifying indicia and is configured to respond to a query only when addressed by the identifying indicia and the data manager is configured to query the tag with its identifying indicia and is configured to transmit information to the tag, to receive information from the tag, or combination thereof. The information can be tag-specific information, general information, or a combination thereof. In an embodiment, the system includes a plurality of tags. In such a system, the data manager can be configured to query each tag with its distinct identifying indicia and is configured transmit information to the tag, receive information from the tag, or combination thereof. In an embodiment, the information in each tag can be tag-specific information, general information, or a combination thereof.

The data manager can be configured to communicate with the beacon, the tag, or the beacon and the tag over the first frequency at a first power level. The data manager can be configured to obtain tag-specific information from the tag, to store the tag-specific information, to transmit the tag-specific information, or combination thereof. In an embodiment, the data manager is configured to obtain tag-specific information from the beacon, to store the tag-specific information, to transmit the tag-specific information, or a combination thereof. The tag-specific information can include, for example, time that the tag was in proximity to a beacon and/or reader.

The data manager can transmit information, for example, to a display device, a processing device, or a display and processing device. In certain embodiments, the display device, the processing device, or the display and processing device can include a personal digital assistant, a notebook computer, a desktop computer, a server computer, a database stored on a computing device, or a plurality thereof.

In an embodiment, the system includes a plurality of tags. In such an embodiment, the reader can be configured to obtain tag-specific information from each tag, to store the tag-specific information, to transmit the tag-specific information, or combination thereof. The tag-specific information can include time that the tag was in proximity to a beacon/reader, the data manager, or both. The data manager can transmit data from a plurality of tags to a display device, a processing device, or a display and processing device. Again, the display device, the processing device, or the display and processing device can include a personal digital assistant, a notebook computer, a desktop computer, or a plurality thereof.

In an embodiment, the data manager (further, also) includes a display device, a processing device, or a display and processing device.

### Inventory Database

The data manager can either include or communicate with an inventory database. The inventory database stores information indicating the current location of each tagged item. In an embodiment, the inventory database also can store information indicating when a tagged item entered the location. Optionally, the inventory database can store information indicating a location history of the tagged item. Other information, for example, a description of the inventory item, a maintenance history of the inventory item, and a designated location for the inventory item, also can be stored.

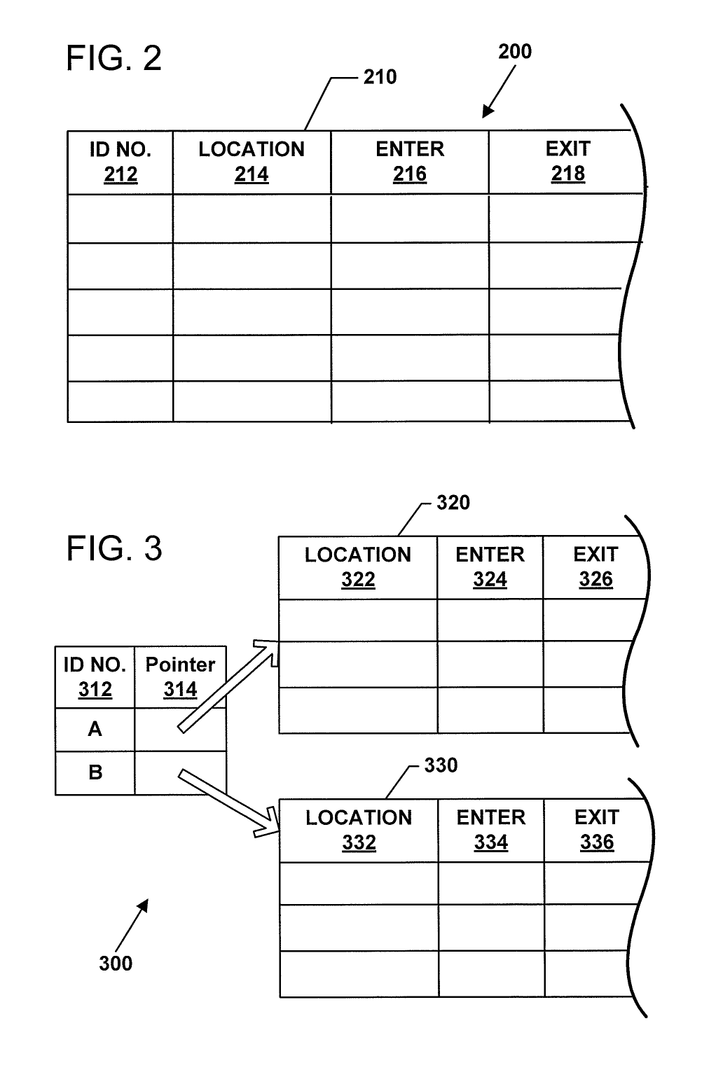

FIGS. 2 and 3 are schematic block diagrams illustrating different examples of an inventory database 200, 300. The inventory database 200, 300 associates an inventory identification number, which is assigned to an inventory item, with a location. The content of the inventory database 200, 300 is updated by the data manager, such as data manager 110 of FIG. 1.

The inventory database 200 shown in FIG. 2 includes a single table 210 for managing inventory items by assigned identification numbers. For example, the identification number of an inventory item can be listed in a first column 212 and the current location of the inventory item can be listed in a second column 214. The inventory database 200 also can include additional columns (i.e., or rows) to manage other types of information. For example, as shown in FIG. 2, the inventory database 200 also can associate entry times (i.e., column 216) and exit times (i.e., column 218) with an identification number and location. Examples of yet additional information can include a designated location for the inventory item, a name and/or description of the inventory item, a maintenance status of the inventory item, a picture of the inventory item, a price of the inventory item, an expiration date of the inventory item, a battery replacement date for the radio tag coupled to the inventory item, and other information pertaining to the inventory item and/or the radio tag coupled to the inventory item.

The inventory database 300 shown in FIG. 3 includes multiple relational databases. For example, the inventory database 300 can include a key table 310 containing a list (e.g., see column 312) of identification numbers (i.e., keys) and an inventory table 320, 330 for each identification number in the key table 310. The key table 310 also can include pointers (e.g., see column 314) for each identification number linking the identification number to the corresponding inventory table 320, 330.

Each inventory table 320, 330 can manage inventory information, such as location (e.g., see columns 322, 332), entry time (e.g., see columns 324, 334), exit time (e.g., see columns 326, 336), name, description, or any other desired information, such as the information stored in table 210 of inventory database 200. By associating an inventory table 320, 330 with each identification number, a location history can be stored for each item. Alternatively, a location history can be stored within the single inventory table 210 of database 200.

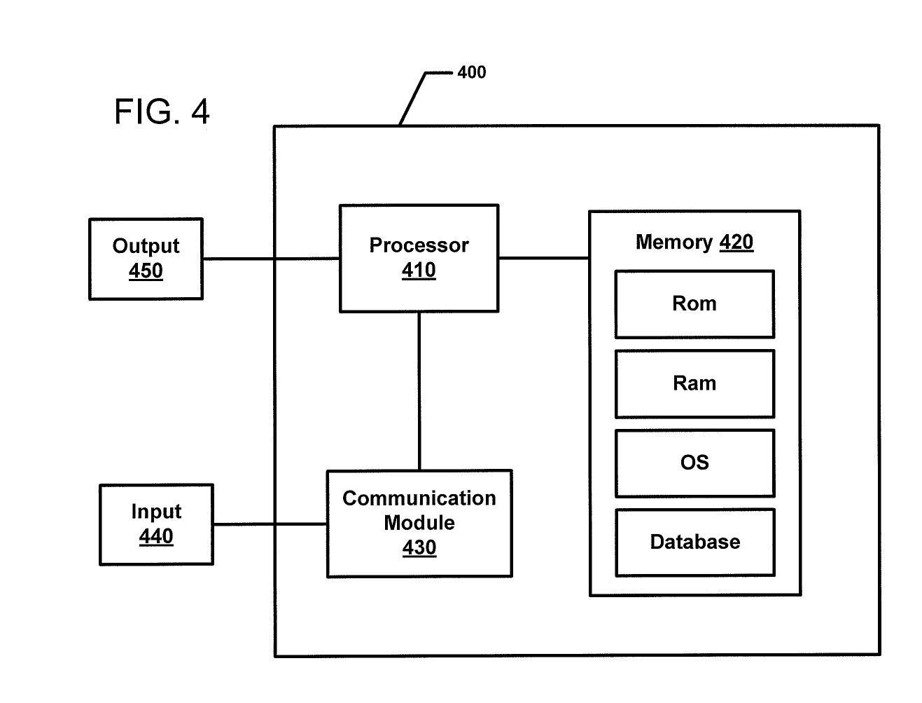

In general, an inventory database, such as inventory databases 200, 300, can be implemented, stored, and edited on a data manager. In an embodiment, the data manager is a computing device. Referring to FIG. 4, an example computing device 400 configured to implement an inventory database in accordance with the principles of the present disclosure is shown. The computing device 400 includes a processor 410 and memory 420. Non-limiting examples of computing devices 400 include a desktop computer, a notebook computer, a personal digital assistant (PDA), a smart phone, a cellular phone, a server computer, and the like.

The memory 420 can include read-only memory (ROM) 422 and/or random-access memory (RAM) 424. An appropriate operating system (OS) can be stored within memory 420. The memory 420 of the computing device 400 also can store one or more inventory databases, such as databases 200, 300. Additional software for implementing the inventory databases and/or the inventory management system also can be stored.

The computing device 400 also can include a communications module 430. The communications module 430 can connect to devices external of the computing device 400 to transmit and receive information. In an embodiment, the communications module 430 is configured to communicatively couple the computing device 400 to another computing device (not shown). In another embodiment, the communications module 430 is configured to communicate with the data manager 110, beacons/readers 120, 120′, and/or the radio tags 130. For example, the communications module 430 can be configured to receive transmission from a radio that meets IEEE Standard 802.15.4 (a ZigBee type radio).

The computing device 400 typically includes an input 440 and an output 450. The input 440 enables a user to submit information and/or data requests to the computing device 400. Non-limiting examples of input 440 include a keyboard, a mouse, a touch-sensitive display, a trackball, a jog wheel, a light pen, a microphone, a camera, and an RFID receiver. The output 450 enables information stored in the database to be displayed to one or more users. Non-limiting examples of output 450 include a display screen, a printer, a projector, and a speaker.

### Methods for Managing Inventory

The present invention relates to a method for managing hospital inventory.

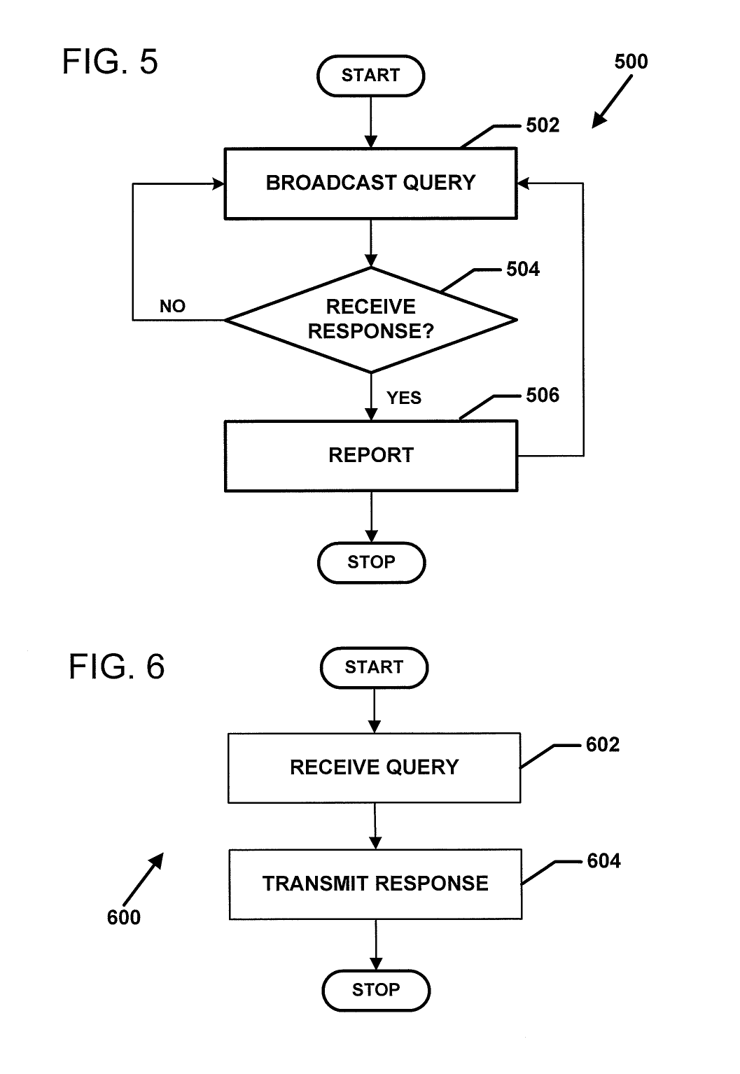

Referring to FIGS. 5 and 6, hospital inventory can be managed using a passive radio tag coupled to the inventory item to be tracked. FIG. 5 is a flowchart illustrating an operational flow for a scanning process 500 by which a beacon, such as beacon 120′ of FIG. 1, determines what tagged inventory items are in proximity to the beacon. FIG. 6 is a flowchart illustrating an operational flow for a response process 600 by which a radio tag responds to the beacons by sending identification information to the beacon.

During the scanning process 500, the beacon 120′ periodically broadcasts a query (at operation 502) asking whether there are any tagged inventory items in proximity to the beacon. In an embodiment, the query is broadcast at regular intervals. In another embodiment, the query is broadcast continuously.

The beacon 120′ determines (at module 504) whether a response has been received from any tagged inventory items. In an embodiment, the beacon stops broadcasting the query when listening for a response. Alternatively, the beacon listens for a response as the query is being broadcast. For example, the beacon can include a first transceiver for broadcasting a query and a second transceiver for receiving a response. The beacon also can include multiple transceivers for receiving multiple responses.

If a response is not received, then the beacon cycles back to the query operation 502 and begins the scanning process 500 again. If a response has been received, the beacon reports (at operation 506) the response to the data manager. For example, if a tagged item responds with an identification number, then the beacon may report the identification number to the data manager. In an embodiment, the beacon may report information indicating the identity and/or the location of the beacon to the data manager. Alternatively, the data manager may know where the beacon is located without receiving that information from the beacon. In another embodiment, the beacon can report an entry time for the tagged item to the data manager. In another embodiment, additional information provided by the radio tag can be transmitted to the data manager.

In an embodiment, before reporting the identification signal, the beacon may determine whether the radio tag also responded to the previous query. For example, the beacon may store information indicating which identification signals were received in response to a previous query. If the identification signal was received during the previous response period, then the beacon may elect not to report receipt of the identification signal, thereby reducing the number of reports sent to the data manager and reducing the power consumed.

During the response process 600, a radio tag, such as radio tag 130, coupled to an inventory item receives (at operation 602) the query broadcast by the beacon if the radio tag is in range of the beacon. The radio tag responds (at operation 604) by transmitting a reply to the beacon. In an embodiment, the radio tag responds using powered obtained from the received query signal. In another embodiment, the radio tag responds using an internal power source.

In an embodiment, the radio tag transmits the reply once. In another embodiment, the radio tag transmits the reply repeatedly over a period of time to maximize the chances of the beacon receiving the reply. In an embodiment, the radio tag repeats the signal according to a broadcast schedule. For example, if multiple radio tags are in range of the beacon, then multiple tags may attempt to reply to the query. The beacon may not be equipped to receive multiple replies concurrently. Therefore, repeating the reply increases the chances of the beacon receiving the reply at a different time than replies of other radio tags.

In an embodiment, the radio tag responds on the same frequency on which the beacon broadcasted the query. In another embodiment, the radio tag responds on a different frequency. In another embodiment, the radio tag responds on multiple frequencies, which may or may not include the frequency on which the query was broadcast by the beacon.

In an embodiment, before responding to the query, the radio tag may determine whether the most recent query received by the radio tag was received from the same beacon. For example, the query signal may identify the beacon or the location of the beacon. If the query signal received during the previous response period was broadcast by the same beacon, then the radio tag may elect not to respond to the query signal, thereby reducing the number of signal sent to the beacon, the number of reports sent to the data manager, and thereby reducing the power consumed by the radio tag.

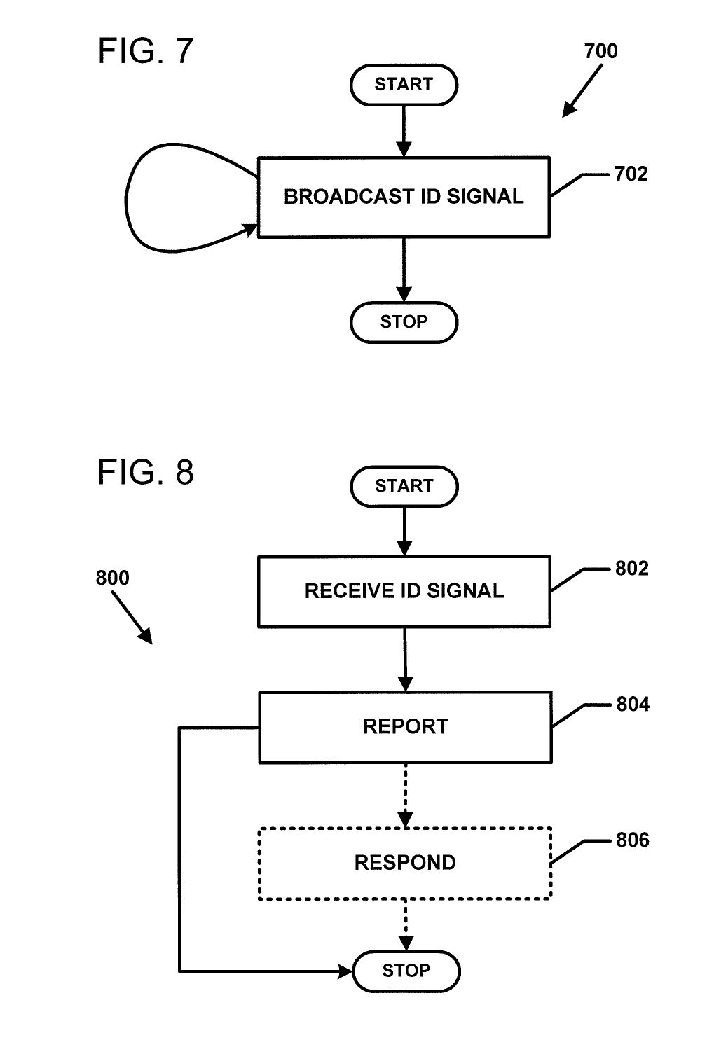

Referring to FIGS. 7 and 8, hospital inventory can be managed using an active radio tag coupled to the inventory item to be tracked. FIG. 7 is a flowchart illustrating an operational flow for a broadcasting process 700 by which a radio tag, such as radio tag 130 of FIG. 1, transmits an identification signal. FIG. 8 is a flowchart illustrating an operational flow for a reporting process 800 implemented by a reader, such as beacon 120 of FIG. 1, when a radio tag enters the vicinity of the reader.

During the broadcasting process 700, the radio tag periodically transmits (at operation 702) an identification signal over a predetermined range. In an embodiment, the radio tag continuously transmits an identification signal. In another embodiment, the radio tag transmits the identification signal according to a duty cycle. For example, the radio tag can transmit the identification signal according to a full duplex duty cycle. In another embodiment, the radio tag can transmit the identification signal according to a half duplex duty cycle. In an embodiment, the radio tag transmits the identification signal multiple times a second. In another embodiment, the radio tag transmits the identification signal once every few seconds.

During the reporting process 800, the reader receives (at operation 802) an identification signal from a radio tag within range of the reader. When the identification signal is received, the reader transmits (at operation 804) a signal to the data manager indicating the received identification signal. In an embodiment, the reader transmits information indicating a time at which the signal is received. In another embodiment, the reader transmits additional information provided by the radio tag.

In another embodiment, before reporting the identification signal, the reader may determine whether the previous identification signal received was transmitted by the same radio tag. For example, the reader may store information indicating which identification signals were received within a predetermined period of time (e.g., the last few seconds, minutes, hours, days, weeks, months, years, etc.). If the identification signal was received within a predetermined period of time, then the reader may elect not to report receipt of the identification signal, thereby reducing the number of reports sent to the data manager and reducing the power consumed by the reader.

In another embodiment, the reader can respond (at operation 806) to the radio tag during the reporting process 800. For example, the reader can respond by transmitting information indicating an identity of the reader and/or a location of the reader to the radio tag.

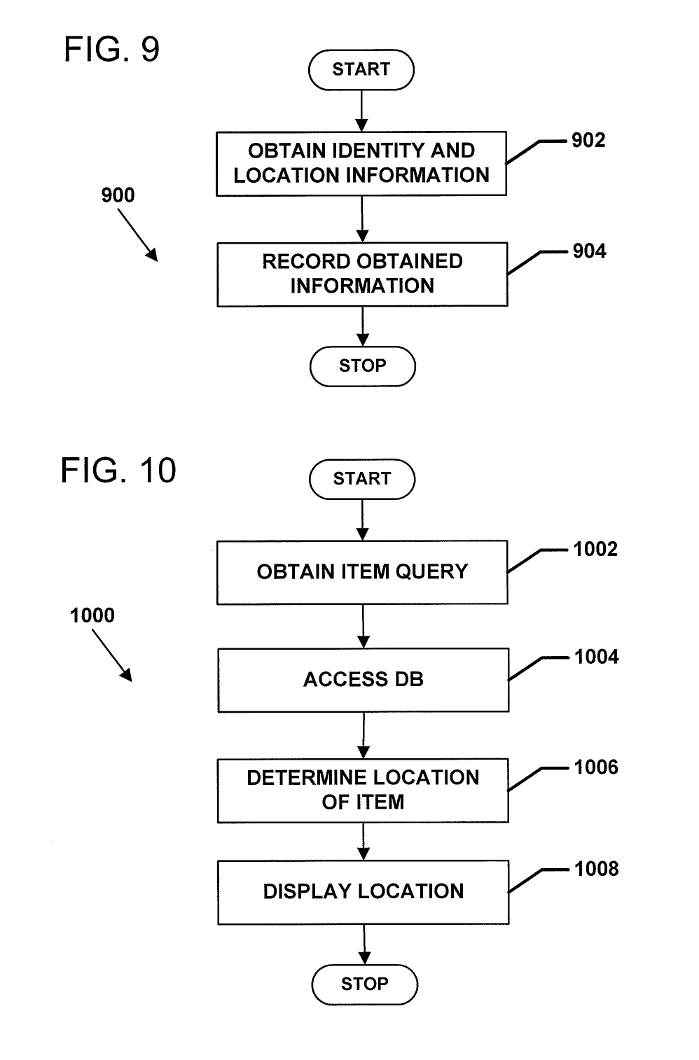

FIGS. 9-10 are flowcharts illustrating how the data manager interacts with the inventory database. FIG. 9 illustrates a recordation process 900 by which the data manager associates an inventory item with a location. The data manager obtains the identification indicia (e.g., an identification number) and location information of one or more inventory tags (at obtain operation 902). For example, the data manager may receive a transmission from a beacon/reader providing the identification indicia and location information. The data manager records the received identifying indicia and location information (at record operation 904). For example, the data manager may store the indicia and location information in a database for subsequent retrieval.

FIG. 10 illustrates a query process 1000 by which a user can look up a location of a tagged item. The data manager receives a query at obtain operation 1002. In an embodiment, the obtain operation 1002 includes indicia identifying the inventory tag associated with the tagged item. In another embodiment, the obtain operation 1002 includes indicia identifying the tagged item by which the data manager may determine appropriate identifying indicia.

The data manager accesses the location data stored (e.g., in a database) in access operation 1004 and determines a location associated with the identifying indicia in determine operation 1006. The data manager communicates the location of the queried item to the user in display operation 1008. In an embodiment, the data manager displays the location on a display screen.

The present invention may be better understood with reference to the following examples. These examples are intended to be representative of specific embodiments of the invention, and are not intended as limiting the scope of the invention.

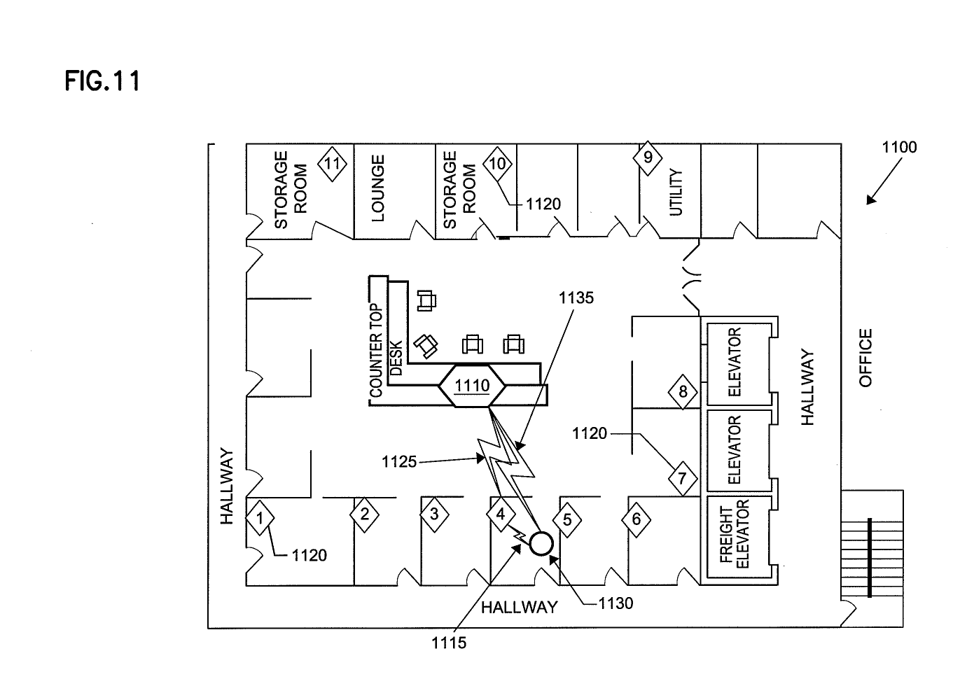

FIG. 11 illustrates an example application of a hospital inventory management system 1100. The management system 1100 includes a data manager 1110, multiple beacons 1120, and multiple inventory tags 1130. The data manager 1110 is arranged at a relatively central location, such as a desk. The beacons 1120 are mounted within rooms of the hospital environment. When an inventory item enters a hospital room, the beacon 1120 receives (see 1115) identification information from the inventory tag 1130 and transmits (see 1125) the identification information to the data manager 1110. The beacon 1120 also may transmit location information to the radio tag 1130. In the example shown, the beacons 1120 are number and the beacon number is sent to and recorded by the radio tag 1130. In another embodiment, the inventory tags 1130 may communicate directly with the data manager 1110 (see transmission 1135).

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

We claim:

1. A system for managing inventory within a hospital environment, the system comprising:
at least one inventory tag, the inventory tag being configured to couple to an inventory item, the inventory tag storing an identification indicia, and the inventory tag being configured to broadcast the identification indicia periodically;
at least one beacon, the beacon configured to mount to a location within the hospital environment, the beacon configured to receive and store the identification number of the radio tag when the radio tag moves within range of the beacon, the beacon being further configured to transmit location information to the radio tag; and
a data manager, the data manager being configured to communicate at least with the beacon, the data manager configured to receive a report from the beacon indicating a location of the radio tag and to store the location of the radio tag.

2. The system of claim 1, wherein the range of the beacon is generally coterminous with an area of interest.

3. The system of claim 1, wherein the area of interest includes a hospital room.

4. The system of claim 1, wherein the information generated upon receiving the beacon signal comprises a duration of time the radio tag is located within the range of the beacon.

5. The system of claim 1, comprising a plurality of beacons.

6. The system of claim 1, comprising a plurality of inventory tags, each inventory tag being disposed on an item of inventory and storing tag information identifying that item.

7. The system of claim 1, wherein the inventory tag is configured to broadcast the identification indicia in response to a query signal from the beacon.

8. The system of claim 1, wherein the inventory tag is configured to broadcast the identification indicia at predetermined intervals.

9. The system of claim 1, wherein the data manager is configured to process data generated by the inventory tag, by the beacon, or a combination thereof.

10. The system of claim 1, wherein the data manager is configured to display information about a status of an inventory item in response to a location query on the inventory item.

11. A method for managing inventory within a hospital environment, the method comprising:
coupling at least one inventory tag to an inventory item;
storing an identification number on the inventory tag;
broadcasting the identification number periodically from the inventory tag;
receiving at a beacon the identification number broadcasted from the inventory tag to determine a location of the inventory item coupled to the inventory tag; and
reporting the location of the inventory item to a data manager.

12. The method of claim 11, further comprising transmitting information indicating the location of the inventory item to the inventory tag.

13. The method of claim 11, wherein broadcasting the identification number periodically comprises broadcasting the identification number at predetermined time intervals.

14. The method of claim 11, wherein broadcasting the identification number periodically comprises broadcasting the identification number in response to query signals received at the inventory tag from the beacon.

15. The method of claim 11, further comprising storing a history of the inventory item on the inventory tag.

16. The method of claim 11, further comprising storing a history of the inventory item on the beacon, the beacon obtaining the history from the inventory tag.
